(19) United States
(12) Patent Application Publication
(10) Pub. No.: US 2009/0169049 A1
(43) Pub. Date: Jul. 2, 2009

(54) Low Profile Audio Speaker

(76) Inventor: Szu-Wei Sun, Kueishan Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/966,533

(22) Filed: Dec. 28, 2007

(51) Int. Cl. H04R 1/00

(52) U.S. Cl. 381/423

(57) ABSTRACT

A low profile audio speaker having a power less than 5W includes a concave chassis; a magnet secured onto a bottom of the chassis; a top plate mounted on the magnet; a mounting flange secured to a peripheral edge of the chassis; an outer peripheral corrugation having an outer edge secured to the mounting flange; a central diaphragm secured to the peripheral corrugation; and a voice coil extending downward from the diaphragm toward the chassis with the magnet and the top plate being surrounded. The peripheral corrugation is formed of PEI, PEN, PET, foam, or fabric. The peripheral corrugation is shaped as a circle or an oval. The peripheral corrugation includes at least two grooves and alternate ridges with the outermost ridge being flattened to be secured onto the top of the mounting flange. The diaphragm is formed of PEI, PEN, PET, foam, or fabric.

### BACKGROUND OF THE INVENTION

1. Field of Invention

The invention relates to audio speakers and more particularly to a compact audio speaker having a power less than 5 W, a minimal depth, a decreased lowest resonance frequency, and improved audio characteristics including high-fidelity and high volume.

2. Description of Related Art

A conventional type of speaker is of disk shape. The speaker has a peripheral corrugation having at least two concentric grooves. Such type of speaker (i.e., large speaker) typically has a music power of more than 5 W. The peripheral corrugation and diaphragm of the speaker are made of PP (polypropylene), rubber, or TPE (thermoplastic elastomer). However, peripheral corrugation and diaphragm made of the above material are relatively heavy, resulting in a decrease of audio quality. Hence, such materials are not appropriate for the manufacturing of compact speaker components.

Some components of large speaker are made of rubber for the consideration of increasing volume and improving audio characteristics. However, components of compact speaker can have an increased weight and decreased volume if they are made of rubber. Hence, rubber also is not a material appropriate for the manufacturing of compact speaker components.

However, a speaker having a decreased depth may not have a decreased resonance frequency. As a result, audio quality of the speaker in the low frequency range is lowered undesirably.

Moreover, ridges of the peripheral corrugation have an increased height, resulting in an increase of speaker height. This is not desired for the manufacturing of speaker having a shallow overall dimension.

There have been numerous suggestions in prior patents for compact audio speakers. For example, U.S. Pat. No. 6,862,361 discloses an audio speaker having a minimal depth. Thus, continuing improvements in the exploitation of low profile audio speaker are constantly being sought.

### SUMMARY OF THE INVENTION

It is therefore one object of the invention to provide a compact audio speaker having a power less than 5 W, a minimal depth, a decreased lowest resonance frequency, and improved audio characteristics including high-fidelity and high volume.

In one aspect of the invention there is provided an audio speaker having a power less than 5 W, comprising a concave chassis; a magnet secured onto a bottom of the chassis; a top plate mounted on the magnet; a mounting flange secured to a peripheral edge of the chassis; an outer peripheral corrugation having an outer edge secured to the mounting flange; a central diaphragm secured to the peripheral corrugation; and a voice coil extending downward from the diaphragm toward the chassis with the magnet and the top plate being surrounded, wherein the peripheral corrugation is formed of PEI (polyethylene imide), PEN (polyethylene naphthalate), or. PET (polyethylene terephthalate), the peripheral corrugation is shaped as a circle or an oval, the peripheral corrugation includes at least two grooves and alternate ridges, and the outermost one of the ridges is flattened to be secured onto the top of the mounting flange; and wherein the diaphragm is formed of PEI, PEN, or PET

In another aspect of the invention there is provided an audio speaker having a power less than 5 W, comprising a concave chassis; a magnet secured onto a bottom of the chassis; a top plate mounted on the magnet; a mounting flange secured to a peripheral edge of the chassis; an outer peripheral corrugation having an outer edge secured to the mounting flange; a central diaphragm secured to the peripheral S corrugation; and a voice coil extending downward from the diaphragm toward the chassis with the magnet and the top plate being surrounded, wherein the peripheral corrugation is formed of fabric, the peripheral corrugation is shaped as a circle or an oval, the peripheral corrugation includes at least two grooves and alternate ridges, and the outermost one of the ridges is flattened to be secured onto the top of the mounting flange; and wherein the diaphragm is formed of fabric.

In a further aspect of the invention there is provided an audio speaker having a power less than 5 W, comprising a concave chassis; a magnet secured onto a bottom of the chassis; a top plate mounted on the magnet; a mounting flange secured to a peripheral edge of the chassis; an outer peripheral corrugation having an outer edge secured to the mounting flange; a central diaphragm secured to the peripheral corrugation; and a voice coil extending downward from the diaphragm toward the chassis with the magnet and the top plate being surrounded, wherein the peripheral corrugation is formed of foam, the peripheral corrugation is shaped as a circle or an oval, the peripheral corrugation includes at least two grooves and alternate ridges, and the outermost one of the ridges is flattened to be secured onto the top of the mounting flange; and wherein the diaphragm is formed of foam.

Preferably, the peripheral corrugation and the diaphragm are formed as separate components and are glued together.

Preferably, the peripheral corrugation and the diaphragm are formed integrally.

Preferably, there is further provided a shock absorbing layer of PU (polyurethane) coated on the tops of the peripheral corrugation and the diaphragm.

The above and other objects, features and advantages of the invention will become apparent from the following detailed description taken with the accompanying drawings.

### BRIEF DESCRIPTION OF THE DRAWINGS

FIG. 1 is a longitudinal sectional view of a first preferred embodiment of audio speaker according to the invention;

FIG. 2 is a top plan view of the audio speaker of FIG. 1;

FIG. 3 is an enlarged longitudinal sectional view of the peripheral corrugation and the diaphragm of FIG. 1;

FIG. 4 is an enlarged longitudinal sectional view of peripheral corrugation and diaphragm of a second preferred embodiment of audio speaker according to the invention;

FIG. 5 is a perspective view of the peripheral corrugation and the diaphragm of FIG. 4;

FIG. 6 is an enlarged longitudinal sectional view of peripheral corrugation and diaphragm of a third preferred embodiment of audio speaker according to the invention; and

FIG. 7 is an enlarged longitudinal sectional view of peripheral corrugation and diaphragm of a fourth preferred embodiment of audio speaker according to the invention.

### DETAILED DESCRIPTION OF THE INVENTION

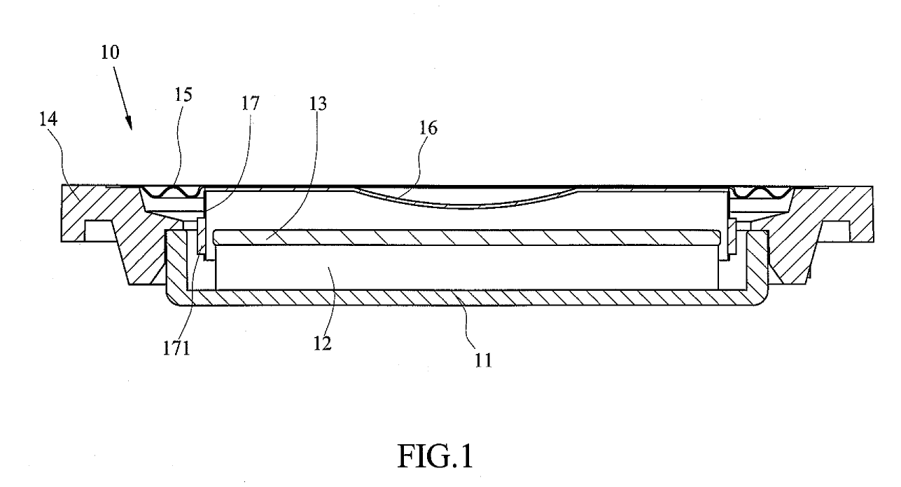

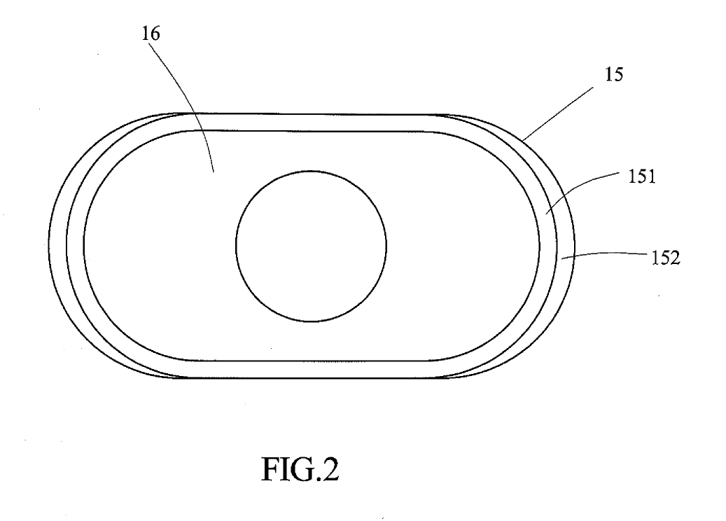

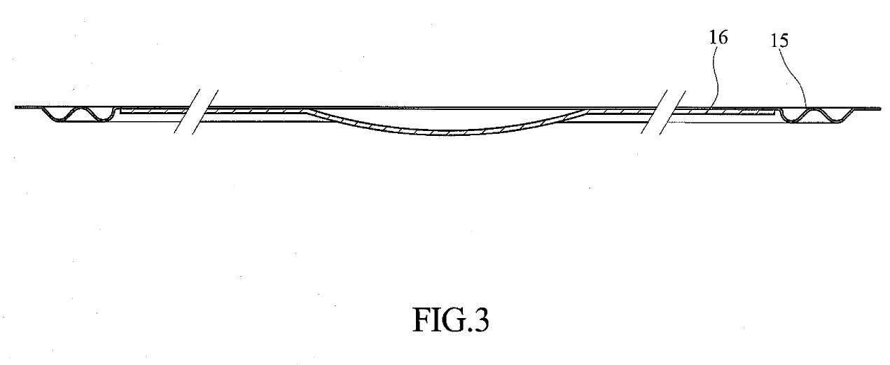

Referring to FIGS. 1 to 3, an audio speaker 10 in accordance with a first preferred embodiment of the invention is shown. Preferably, the speaker 10 has a power less than 5 W in this and any of the following preferred embodiments.

The speaker 10 comprises a concave chassis 11, a magnet 12 secured onto a flat bottom of the chassis 11, a top plate 13 mounted on the magnet 12, a mounting flange 14 secured to a peripheral edge of the chassis 11, a unit including an outer peripheral corrugation 15 and a central diaphragm 16 in which the peripheral corrugation 15 having an outer edge secured to the mounting flange 14 and the peripheral corrugation 15 and the diaphragm 16 are either (i) separate components and secured together by applying adhesive in the manufacturing process or (ii) formed integrally in the manufacturing process as detailed later, and a voice coil 17 extending downward from the diaphragm 16 toward the chassis 11 with both the magnet 12 and the top plate 13 being surrounded, the voice coil 17 having a plurality of coil turns 171.

The speaker 10 is shaped as an oval and the diaphragm 16 is also an oval. The peripheral corrugation 15 has two grooves (not numbered) and two alternate ridges (not numbered). Note that the peripheral corrugation 15 may have more than two grooves and two alternate ridges in other embodiments. The outermost ridge is flattened so as to secure onto the top surface of the mounting flange 14 for decreasing height of the produced speaker.

Both the peripheral corrugation 15 and the diaphragm 16 are made of PEI (polyethylene imide), PEN (polyethylene naphthalate), PET (polyethylene terephthalate), fabric, or a lightweight core material (e.g., foam). Hence, the speaker 10 can have a relatively flexible peripheral edge, a shallow overall dimension, and a decreased lowest resonance frequency. In addition, PU (polyurethane) may be added as a top layer on the peripheral corrugation 15 and the diaphragm 16 by coating for shock absorption. In other embodiments, both the peripheral corrugation and the diaphragm are shaped as a circle as detailed later.

PEI, PEN and PET are flexible materials and thus speakers formed of any of the above materials can be made compact and have improved audio characteristics including high-fidelity and high volume.

Each of PEI, PET and PEN is suitable for manufacturing either (i) separate diaphragm and peripheral corrugation or (ii) integral diaphragm and peripheral corrugation. Speakers formed of PEI, PET, or PEN are types of headphone and earbud.

Speakers formed of PET have a smallest depth and are less resistant to high heat

Speakers formed of PEN have an intermediate depth and are more resistant to high heat. Speakers formed of PEI have a highest depth and are very much resistant to high heat. After each of PET, PEN and PEI being manufactured either (i) separate diaphragm and peripheral corrugation or (ii) integral diaphragm and peripheral corrugation, PU (polyurethane) may be either added on the tops of the peripheral corrugation 15 and the diaphragm 16 by coating for shock absorption or not.

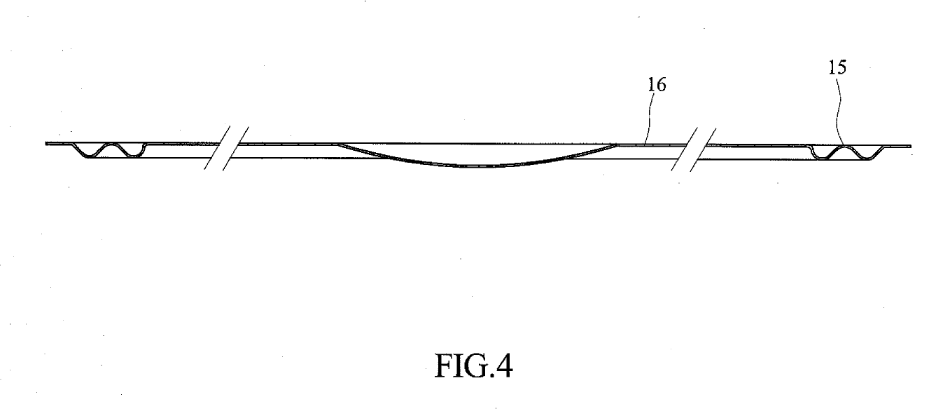

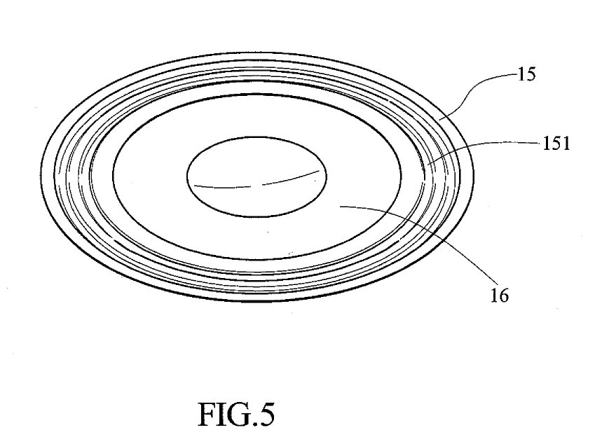

Referring to FIGS. 4 and 5, an audio speaker in accordance with a second preferred embodiment of the invention is shown. The characteristics of the second preferred embodiment are that the peripheral corrugation 15 and the diaphragm 16 are formed of the same material and are formed integrally in the manufacturing process.

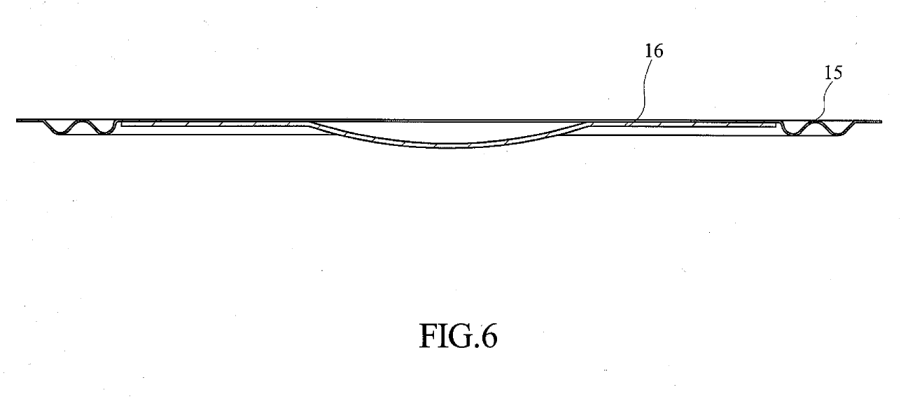

Referring to FIG. 6, an audio speaker in accordance with a third preferred embodiment of the invention is shown. The characteristics of the third preferred embodiment are that both the peripheral corrugation 15 and the diaphragm 16 are formed as separate components and secured together by applying adhesive in the manufacturing process. The peripheral corrugation 15 is shaped as a circle and the diaphragm 16 is shaped as a disk.

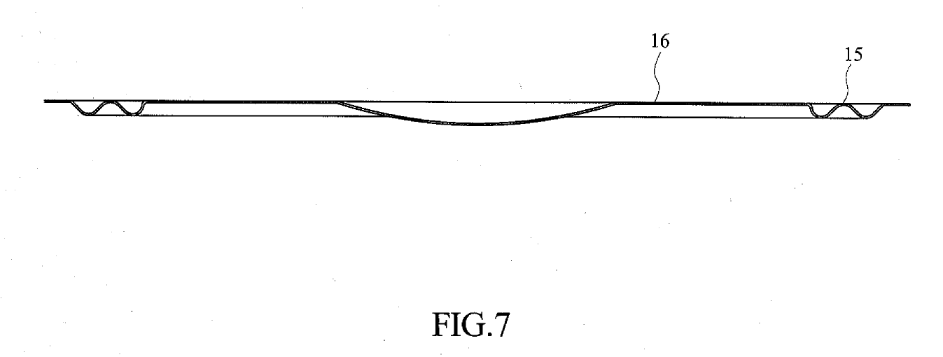

Referring to FIG. 7, an audio speaker in accordance with a fourth preferred embodiment of the invention is shown. The characteristics of the fourth preferred embodiment are that both the peripheral corrugation 15 and the diaphragm 16 are formed integrally in the manufacturing process. Also, the peripheral corrugation 15 is shaped as a circle and the diaphragm 16 is shaped as a disk.

While the invention herein disclosed has been described by means of specific embodiments, numerous modifications and variations could be made thereto by those skilled in the art without departing from the scope and spirit of the invention set forth in the claims.

What is claimed is:

1. An audio speaker having a power less than 5 W, comprising:
a concave chassis;
a magnet secured onto a bottom of the chassis;
a top plate mounted on the magnet;
a mounting flange secured to a peripheral edge of the chassis;
an outer peripheral corrugation having an outer edge secured to the mounting flange;
a central diaphragm secured to the peripheral corrugation; and
a voice coil extending downward from the diaphragm toward the chassis with the magnet and the top plate being surrounded,
wherein the peripheral corrugation is formed of PEI (polyethylene imide), PEN (polyethylene naphthalate), or PET (polyethylene terephthalate), the peripheral corrugation is shaped as a circle or an oval, the peripheral corrugation includes at least two grooves and alternate ridges, and the outermost one of the ridges is flattened to be secured onto the top of the mounting flange; and
wherein the diaphragm is formed of PEI, PEN, or PET.

2. The audio speaker of claim 1, wherein the peripheral corrugation and the diaphragm are formed as separate members and are glued together.

3. The audio speaker of claim 1, wherein the peripheral corrugation and the diaphragm are formed integrally.

4. The audio speaker of claim 1, further comprising a shock absorbing layer of PU (polyurethane) coated on the tops of the peripheral corrugation and the diaphragm.

5. An audio speaker having a power less than 5 W, comprising:
a concave chassis;
a magnet secured onto a bottom of the chassis;
a top plate mounted on the magnet;
a mounting flange secured to a peripheral edge of the chassis;
an outer peripheral corrugation having an outer edge secured to the mounting flange;
a central diaphragm secured to the peripheral corrugation; and
a voice coil extending downward from the diaphragm toward the chassis with the magnet and the top plate being surrounded,
wherein the peripheral corrugation is formed of fabric, the peripheral corrugation is shaped as a circle or an oval, the peripheral corrugation includes at least two grooves and alternate ridges, and the outermost one of the ridges is flattened to be secured onto the top of the mounting flange; and
wherein the diaphragm is formed of fabric.

6. The audio speaker of claim 5, wherein the peripheral corrugation and the diaphragm are formed as separate members and are glued together.

7. The audio speaker of claim 5, wherein the peripheral corrugation and the diaphragm are formed integrally.

8. The audio speaker of claim 5, further comprising a shock absorbing layer of PU (polyurethane) coated on the tops of the peripheral corrugation and the diaphragm.

9. An audio speaker having a power less than 5 W, comprising:
a concave chassis;
a magnet secured onto a bottom of the chassis;
a top plate mounted on the magnet;
a mounting flange secured to a peripheral edge of the chassis;
an outer peripheral corrugation having an outer edge secured to the mounting flange;
a central diaphragm secured to the peripheral corrugation; and
a voice coil extending downward from the diaphragm toward the chassis with the magnet and the top plate being surrounded,
wherein the peripheral corrugation is formed of foam, the peripheral corrugation is shaped as a circle or an oval, the peripheral corrugation includes at least two grooves and alternate ridges, and the outermost one of the ridges is flattened to be secured onto the top of the mounting flange; and
wherein the diaphragm is formed of foam.

10. The audio speaker of claim 9, wherein the peripheral corrugation and the diaphragm are formed as separate members and are glued together.

11. The audio speaker of claim 9, wherein the peripheral corrugation and the diaphragm are formed integrally.

12. The audio speaker of claim 9, further comprising a shock absorbing layer of PU (polyurethane) coated on the tops of the peripheral corrugation and the diaphragm.
